(19) United States
(12) Patent Application Publication
(10) Pub. No.: US 2023/0368451 A1
(43) Pub. Date: Nov. 16, 2023

(54) SYSTEM AND METHOD FOR AI ASSISTED CHARACTER POSE AUTHORING

(71) Applicant: Unity Technologies SF, San Francisco, CA (US)

(72) Inventors: Florent Benjamin Bocquelet, La Motte-Servolex (FR); Dominic Laflamme, Hudson (CA); Boris Oreshkin, Mont-Royal (CA); Félix Gingras Harvey, Montréal (CA)

(21) Appl. No.: 18/197,669

(22) Filed: May 15, 2023

Related U.S. Application Data
(60) Provisional application No. 63/341,976, filed on May 13, 2022.

(51) Int. Cl. G06T 13/00; G06N 20/00

(52) U.S. Cl. CPC G06T 13/00; G06N 20/00

(57) ABSTRACT

A method of optimizing a pose of a character is disclosed. An input is received. The input defines one or more effectors. A pose is generated for the character using a learned inverse kinematics (LIK) machine-learning (ML) component. The LIK ML component is trained using a motion dataset. The generating of the pose is based on one or more criteria. The one or more criteria include explicit intent expressed as the one or more effectors. The generated pose is adjusted using an ordinary inverse kinematics (OIK) component. The OIK component solves an output from the LIK ML component to increase an accuracy at which the explicit intent is reached. A final pose is generated from the adjusted pose. The generating of the final pose includes applying a physics engine (PE) to an output from the OIK component to increase a physics accuracy of the pose.

### CROSS-REFERENCE TO RELATED APPLICATIONS

This application claims the benefit of U.S. Provisional Application No. 63/341,976, filed May 13, 2022, which is incorporated by reference herein in its entirety.

### TECHNICAL FIELD

The subject matter disclosed herein generally relates to the technical field of computer graphics systems, and in one specific example, to computer systems and methods for creating and manipulating character poses for animation.

### BACKGROUND

In the world of computer graphics animation, automated character posing is a difficult problem to solve, and often involves compromises. Existing systems often do not produce natural looking poses or have a tradeoff between a natural looking pose and a pose which is physically correct with respect to its surroundings. In addition, existing systems may ignore or override a user's intent in order to create a physically correct pose.

### BRIEF DESCRIPTION OF THE DRAWINGS

Features and advantages of example embodiments of the present disclosure will become apparent from the following detailed description, taken in combination with the appended drawings, in which:

FIG. 1 is a schematic illustrating a method for real-time AI assisted character pose authoring, in accordance with one embodiment;

FIG. 2 is a block diagram illustrating an example software architecture, which may be used in conjunction with various hardware architectures described herein; and

FIG. 3 is a block diagram illustrating components of a machine, according to some example embodiments, configured to read instructions from a machine-readable medium (e.g., a machine-readable storage medium) and perform any one or more of the methodologies discussed herein.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that various embodiments of the inventive subject matter may be practiced without these specific details.

A method of optimizing a pose of a character is disclosed. An input is received. The input describes a manipulation of the character. The input defines one or more effectors. A pose is generated for the character using a learned inverse kinematics (LIK) machine-learning (ML) component. The LIK ML component is trained using a motion dataset (e.g., motion capture (MOCAP) and/or video motion dataset). The generating of the pose is based on one or more criteria. The one or more criteria include explicit intent expressed as the one or more effectors. The generated pose is adjusted using an ordinary inverse kinematics (OIK) component. The OIK component solves an output from the LIK ML component to increase an accuracy at which the explicit intent is reached. A final pose is generated from the adjusted pose. The generating of the final pose includes applying a physics engine (PE) to an output from the OIK component to increase a physics accuracy of the pose.

The present disclosure includes apparatuses which perform one or more operations or one or more combinations of operations described herein, including data processing systems which perform these operations and computer readable media which when executed on data processing systems cause the systems to perform these operations, the operations or combinations of operations including non-routine and unconventional operations or combinations of operations.

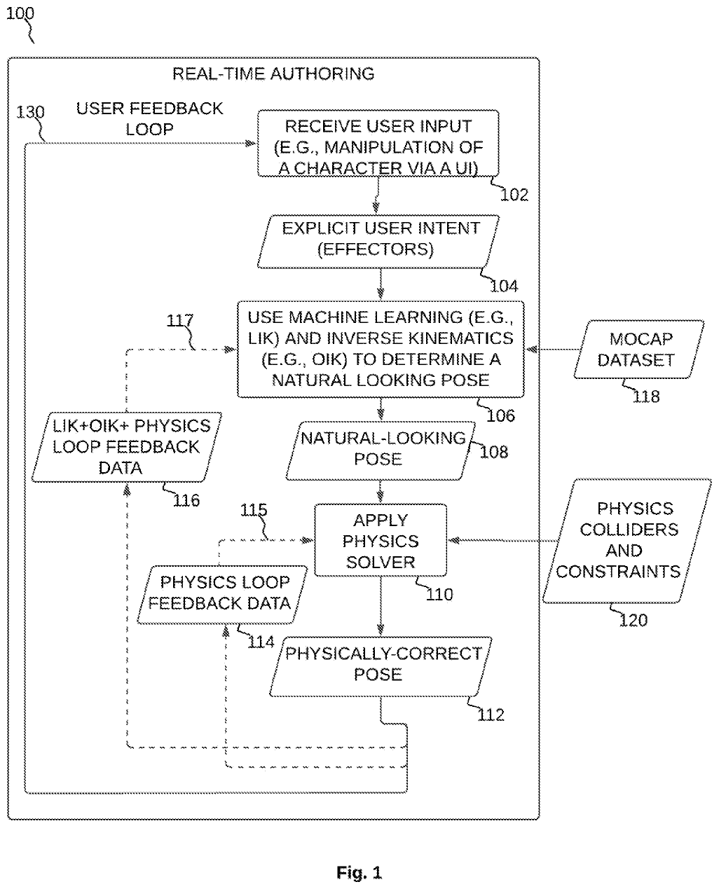

The systems and methods described herein include one or more components or operations that are non-routine or unconventional individually or when combined with one or more additional components or operations, because, for example, they provide a number of valuable benefits to content creators. For example, the systems and methods described herein (e.g., describe with respect to the method shown in FIG. 1), may make human character posing and animation possible for users with little or no animation or artistic experience. This may lower the necessary skill required to make video games (e.g., and animation for movies) that include humanoid characters. For example, in accordance with an embodiment, a machine learning (ML) module (e.g., within operation 106 described below with respect to FIG. 1) interacting with a human user may be used to determine a naturalness of an digital human character pose in order to allow the user to quickly define an overall pose that is both good looking (e.g., natural looking) and that follows the user's artistic input (e.g., input from a user interface). In addition, and as described below with respect to FIG. 1, a physics solver (e.g., within operation 110) may then handle additional pose details related to physics, including avoiding penetrations of objects within an environment surrounding the character and avoiding interpenetrations (e.g., penetrations of the character with itself), which may allow the user to focus on artistic intent. The two systems (e.g., the ML and physics systems) work together in a feedback loop as described in FIG. 1 to allow the user to quickly author a pose that looks great and is physically plausible.

In accordance with an embodiment, the systems and methods described herein treat character posing as a multi-criterion optimization problem in which a goal is to find an optimal solution that includes a full-body pose that best matches a creative design. In some embodiments, the creative design may exist only in the imagination of a user, which is one reason why user input may be used to determine an optimal solution. The systems and methods described herein use at least the following qualitative and quantitative optimization criteria for the posing problem:

1. A naturalness of a character pose (e.g., how realistic it is for a humanoid to be in the character pose).

2. Physics accuracy that includes constraints on self-penetration or penetration with other objects and characters in a surrounding environment.

3. Input that includes explicit user intent. This may include effectors that express positional, rotational and other constraints on a final pose. For example, this may include a constraint on a final position of a wrist joint, or a constraint on a target at which character eyes are supposed to look at, etc.

4. Implicit user intent that includes a concept of the final pose, for example a person sitting on a chair (implicit user intent may be captured with a user feedback loop 130 described below).

An optimization of this problem is highly non-linear and complex; it has no closed-form solution, nor even a formal mathematical definition. The systems and methods described herein describe a solution to this problem, through feedback loops that include a user feedback loop 130, a ML+inverse kinematics (IK)+physics loop 117, and a physics loop 115, which may be referred to as “Interactive Physics and ML character posing”.

Turning now to the drawings, systems and methods, including non-routine or unconventional components or operations, or combinations of such components or operations, for AI assisted character pose authoring in accordance with embodiments of the disclosure are illustrated. In example embodiments, FIG. 1 is a diagram of a method 100 for AI assisted character pose authoring.

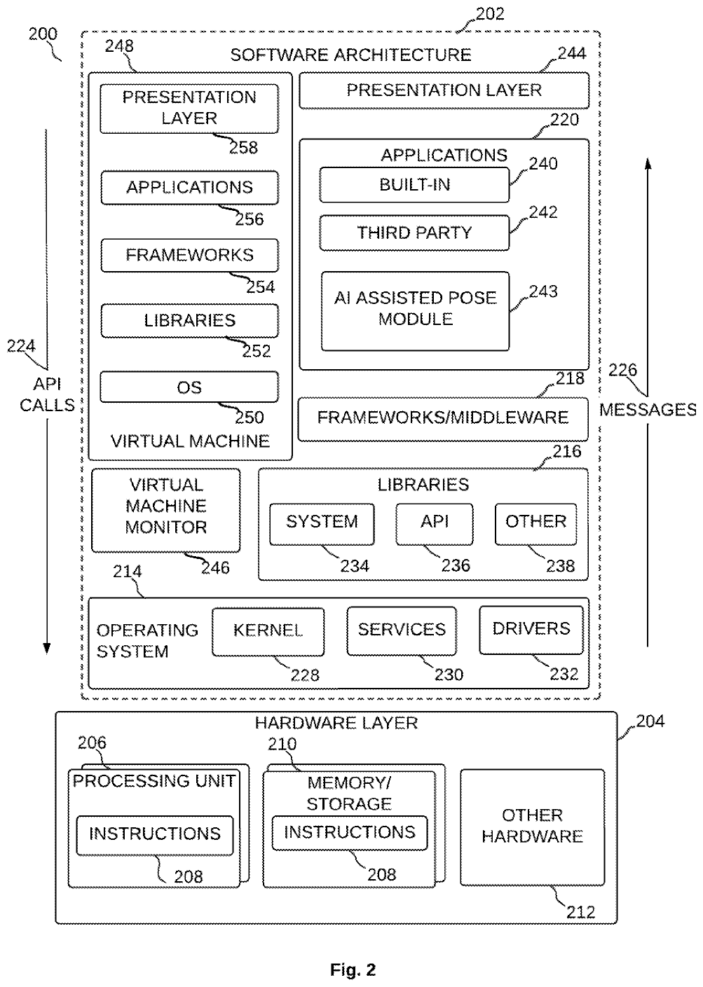

In accordance with an embodiment, the method 100 includes a combination of four components (e.g., modules, systems, sub-systems, or the like): a Learned Inverse Kinematics (LIK) ML component, an Ordinary Inverse Kinematics (OIK) component, a Physics Engine (PE), and User Experience (UX) component (e.g., via a user interface UI) to allow a user to create an optimal pose. In various embodiments, some of the method elements shown in FIG. 1 may be performed concurrently, in a different order than shown, or may be omitted. In accordance with an embodiment, the method 100 may be performed by an AI assisted pose module 243 (e.g., implemented as an application) as shown in FIG. 2.

In accordance with an embodiment, the LIK component is an ML model trained on high quality animation data including motion capture (MOCAP) data and/or character motion video data, wherein the LIK component predicts a full body pose based on partial inputs (e.g., effectors). The prediction may occur during operation 106 as described below. Effectors may define at least positions, local/global rotations, and/or look-at targets of a few joints of a character skeleton. An output full body pose prediction of the LIK component may include global position and/or rotation of a root joint of the skeleton and/or local rotations of some or all other joints of the skeleton.

In accordance with an embodiment, the OIK may be a numerical kinematic equation solver, which splits the skeleton of the character into multiple bone chains and solves for all kinematic parameters of the skeleton, in order of the skeleton hierarchy (e.g., parent chains are solved first). As an example, the OIK solver may be based on Cyclic Coordinates Descent (CCD). The OIK component may operate during operation 106 as described below.

In accordance with an embodiment, the PE component may include physics simulation which applies forces and torques to a physically simulated version of the character in order to both try to match the target pose and fulfill physics constraints such as collisions with external objects and collisions with self. The PE component may operate during operation 110 as described below.

In accordance with an embodiment, the UX component may include a set of user interface manipulators that are configured to receive (e.g., from a user) information about positions, rotations and look-at targets for effectors.

Machine Learning—Inverse Kinematics—Physics Loop

In accordance with an embodiment, as shown in FIG. 1, there is a combined LIK, OIK and PE feedback loop 117 to optimize for the first three criteria described above: including naturalness, physics accuracy, and/or explicit user intent. This includes the LIK solving for criteria that IK and PE cannot solve on their own: this includes solving for full-body posing from sparse input (e.g., generating a full pose from the explicit user intent expressed as effectors wherein a description of only a few effectors are provided), and solving for natural-looking poses (e.g., reproducing good-looking realistic human poses by learning their distribution from training data).

In general, ML models are often bad at solving “hard” constraints (e.g., strict constraints) and are better suited for learning “soft” constraints which have more flexibility in output values. In accordance with an embodiment, during operation 106 and the LIK, OIK, and/or PE feedback loop 117, the OIK may be used to convert one or more of soft constraints learned by the LIK component/model into hard constraints. For example, the OIK may perform position solving on an output from the LIK to ensure that explicit user intent expressed as absolute positions (e.g., via effector data 104 received via the UX component during operation 102) are actually reached with high accuracy.

In accordance with an embodiment, the PE component may be used to solve criteria that the LIK component and/or OIK component cannot, including self-penetration (e.g., collision of the character with itself), and/or other external penetrations including collisions with other objects (floor, props, and so on), and/or characters.

In accordance with an embodiment, as shown in FIG. 1, during operation 102 of the method 100, user input is received, wherein the input describes a manipulation of a character. The input may be received via a user interface wherein a user may be manipulating a displayed character (e.g., moving certain character joints). In accordance with an embodiment, the received input may include data 104 that defines effectors (e.g., a set of effectors), which may represent a description of explicit user intent. The set of effectors may be provided by an external input (e.g., an input of a user via a joystick, mouse, screen tap or other). For example, a user may specify a position for a hand, then provide a hip position, then provide a look-at position for a face, wherein the LIK pose prediction system can produce an output pose 108.

In accordance with an embodiment, during operation 106 of the method 100, the LIK component predicts a full pose of a character based on the user input (e.g., data 104) from operation 102. The criteria for the prediction of the character pose includes naturalness and explicit intent (e.g., via the user input). The LIK component turns a set of user-defined constraints (e.g., the data 104 describing effectors), such as target positions or rotation, into a realistic pose. Generated poses from the LIK component may follow a training distribution from a motion capture (MOCAP) dataset 118 (e.g., or a character motion video set), resulting in a realistic pose even from sparse constraints (e.g., from a minimal set of effectors constraining joints within a character skeleton).

In accordance with an embodiment, as part of operation 106, the OIK component corrects and/or adjusts the predicted pose from the LIK component to better match user inputs, wherein the criteria may be to match explicit intent of the user (e.g., to match with the input data 104) with high accuracy. For example, this may mean that the OIK adjusts the pose which is output from the LIK so that the specified constraints input by the user (e.g., effector descriptions within the data 104) during operation 102 are met. This may mean adjusting a joint position or orientation to match a position or orientation input during operation 102 (e.g., and described in the data 104), and/or it may mean adjusting a head position/orientation to match a gaze target (e.g., a look-at effector described in the data 104) input during operation 102.

In accordance with an embodiment, the Inverse Kinematics steps within the OIK component complement the ML step of the LIK component by improving its accuracy on the explicit user constraints (e.g., constraints within the data 104). For example, the LIK component may output a pose which is natural but does not exactly respect the input constraints received in operation 102, such as a target position. The OIK component uses an iterative process to further correct the predicted pose while better matching target positions. In accordance with an embodiment, the OIK may be based on Cyclic Coordinates Descent (CCD), wherein the skeleton of the character is split into multiple bone chains that are solved separately, in order of the skeleton hierarchy (e.g., parent chains are solved first), and/or wherein the bone chains are dynamically configured depending on which position effectors the user provides.

In accordance with an embodiment, during operation 110, the PE component may take a pose output from the OIK and adjust the pose using a physics simulation, wherein the criteria include physics accuracy. The physics simulation within the PE component guarantees that a final pose is plausible from a physics point of view, e.g., that the character has no interpenetrations with other objects or itself. In accordance with an embodiment, this may include an iterative process during which forces and torques are applied to a physically simulated version of the character in order to try to match the pose obtained from the LIK model (and corrected by the OIK step). Performing multiple iterations may be necessary to guarantee the convergence and the stability of the solver. In accordance with an embodiment, the physics simulation operation 110 may include a mode wherein the simulation always starts from a last pose output by the PE component (e.g., it may not start from a fixed pose, nor from the pose predicted by the LIK or OIK operations). In accordance with an embodiment, the PE component may receive and use physics colliders and constraints 120 that are received by or extracted from an external environment surrounding the character. In addition, the PE component may receive colliders and constraints that define a structure and limit movement of the character skeleton and body.

In accordance with an embodiment, the method 100 may include an LIK-OIK-PE loop 117, wherein results from the physics step (e.g., a physically correct pose 112 from operation 110) are used to enable additional effectors in the ML model used in the LIK component of operation 106, and repeat from operation 106 to operation 110 until a predetermined convergence or number of iterations is complete. In accordance with an embodiment, the additional effectors may be determined by analyzing a discrepancy between the end joint positions generated by the LIK component in a first iteration and the joint positions after OIK-PE correction. For example, joints that undergo significant correction may be marked as new effectors (e.g., physics effectors) and the LIK model may be queried again using a combination of effectors initially supplied by the user and the new physics effectors to obtain pose that is (i) realistically looking and (ii) better satisfies the physics constraints (for example, less physics correction will be required in a next pass of the LIK-OIK-PE loop).

User Feedback Loop 130

In example embodiments, the LIK-OIK-PE loop 117 alone can solve all of the criteria of the initial optimization problem, except one: the implicit user intent. LIK alone, OIK alone, PE alone, or all combined may not be able to solve the implicit user intent in one set of iterations (e.g., using loops 117 and 115) because there is no well-defined objective function for the implicit intent in mathematical terms. In accordance with an embodiment, in order to let the user express and control the implicit intent, the AI assisted character pose authoring method 100 is performed in an iterative and interactive fashion with at least the inclusion of a larger user feedback loop 130. In addition, this is accomplished by starting the physics simulation in operation 110 from a previous physics solver output, with the physics loop feedback data 114, introducing the time dimension as an additional control to the user. The addition of the user feedback loop 130 allows the user to explore the solution space in order to iteratively and interactively find the optimal solution for the implicit criteria that may only be defined in the mind of the user. The user feedback loop 130 may be a closed wherein the user is continuously interacting with the system and can react to an output pose which may be displayed in a UI. The user feedback loon 130 makes the method 100 not fully deterministic (e.g., with respect to a specific input pose) since the output is not always the same for a set of input effectors (e.g., effectors with specified values) since then output depends on how effectors were manipulated over time. For example, a history of past positions/orientations will affect an output pose, in addition to a current position/orientation of pose joints. As an example, if there is an obstacle, manipulating an effector from left to right or from right to left will not produce the same output, even if the final effector configuration is the same. So the order and way of manipulating effectors within operation 102 provides an additional “dimension” that the user can use to pose the character, which may be referred to as “time dimension”. It allows the user to reach a particular pose in ways that are not explicit (e.g., no specific effector is provided).

In accordance with an embodiment, operation 102 may provide a character (e.g., via a user interface) which includes a skeleton rig, wherein the rig is a bone structure associated with a 3D model of the character, and wherein the rig is to be used by the LIK pose prediction system to pose the character in operation 106. A type of character may be associated with a skeleton shape and configuration for the type (e.g., a bipedal human shaped animation skeleton for a human type character, a quadrupedal shaped animation skeleton for a dog type character, and the like). The systems and methods described herein can be applied to any type of character (e.g., to any shape or type of skeleton) including a bipedal human type, a quadrupedal type (e.g., dog, giraffe, elephant), other odd shaped types (e.g., octopus), and more. In accordance with an embodiment, a skeleton may include a hierarchical set of joints and may also include constraints on the joints (e.g., length of bones between joints, angular constraints, and more) which may provide a basic structure for the skeleton. In accordance with an embodiment, the rig may include an associated set of effectors used to capture user intent (e.g., user input) during operation 102. In accordance with an embodiment, an effector of the set of effectors may be of a type, with the types of effectors including a positional effector, a rotational effector, and a look-at effector as described below:

Positional: In accordance with an embodiment, a positional effector includes data describing a position in a world space (e.g., world space coordinates). A positional effector can include subtypes:

Joint effector: In accordance with an embodiment, a joint effector may be a subtype of a positional effector that represents a position of a joint for a character (e.g., such as a desired position for a left foot of bipedal character). In accordance with an embodiment, a joint effector may be a restraint imposed on a joint of a character (e.g., imposed by a user via a user interface during operation 102) which forces the joint to occupy the position defined therein.

Reach effector: In accordance with an embodiment, a reach effector is a subtype of a positional effector that represents a desired target position in a world space (e.g., a target ‘future’ position for a joint effector). In accordance with an embodiment, a reach effector may be associated with a specific joint or joint effector, and may indicate a desired position for the joint (e.g., wherein the desired position may be imposed by a user via a user interface during operation 102). In accordance with an embodiment, a reach effector may not be associated with a specific joint or joint effector, but may indicate a desired position for a part of a character (e.g., a desired position for a left hand of a character to grab or point at).

look-at effector: In accordance with an embodiment, a look-at effector is an effector type that includes a 3D position which represents a desired target position in a world space for a joint, wherein the joint is forced (e.g., imposed by a user via a user interface during operation 102) to orient itself towards the desired target position (e.g., the joint is forced to “look at” the target position). In accordance with an embodiment a look-effector provides an ability to maintain a global orientation of a joint towards a particular global position in a scene (for example, looking at a given object). In accordance with an embodiment, the look-at effector may include data describing the following: a 3D point (e.g., the desired target position), a joint (e.g., a specified joint within a character which must target the desired target position), and a specified axis of the joint which must orient itself to the 3D point (e.g., an axis of the joint which is forced by the LIK pose prediction system to point at the 3D point, wherein the axis may be defined with any arbitrary unit-length vector defining an arbitrary local direction). In accordance with an embodiment, and during a training of a neural network architecture within the LIK pose prediction system, the neural network architecture may be provided with a look-at effector (e.g., including a 3D point in an environment and a specified joint in a character), and may learn to generate a pose of the character wherein the specified joint will additionally satisfy a requirement to look at (e.g., point towards) the 3D point.

Rotational effector: In accordance with an embodiment, a rotational effector may include directional data (e.g., such as a direction vector or an amount and direction of rotation). For example, a directional effector may include a vector specifying a gaze direction, a turning velocity, a hand orientation, and the like. In accordance with an embodiment, a rotational effector may include data which describes a local rotation or local direction which is described relative to an internal coordinate system of a character (e.g., a rotation relative to a character rig or relative to a set of joints for the character). In accordance with an embodiment, a rotational effector may include data which describes a global rotation or global direction which is described relative to a coordinate system which is external to the character (e.g., a rotation relative to a coordinate system external to a character rig or external to a set of joints for the character).

While positional, rotational, and look-at types are described above, embodiments of this present disclosure are not limited in this regard. Other effector types may be defined and used without departing from the scope of this disclosure.

Training

In accordance with an embodiment, the LIK pose prediction system may include one or more stages of fully-connected neural networks trained for pose generation using a variable number and type of input effectors. In accordance with an embodiment, the training may include performing data augmentation on input data, and designing training criterion to improve results of the LIK pose prediction system. In accordance with an embodiment, the training methodology may include a plurality of techniques to regularize model training via data augmentation and teach the model to deal with incomplete and missing inputs.

In accordance with an embodiment, a machine learning training process for the LIK pose prediction system requires as input a plurality of plausible poses for a type of character. In accordance with an embodiment, the plurality of plausible poses may be in the form of an animation clip (e.g., video clip). The input animation clips may be obtained from any existing animation clip repository (e.g., online video clips, proprietary animation clips, etc.), and may be generated specifically for the training (e.g., using motion capture).

In accordance with an embodiment, a LIK pose prediction system may be trained for a type of character (e.g., requiring at least one LIK pose prediction system for posing per type of character). For example, there may be a LIK pose prediction system trained for human type characters, another LIK pose prediction system for dog type characters, another LIK pose prediction system for cat type characters, another LIK pose prediction system for snake type characters, and the like. The plurality of input poses to train an LIK pose prediction system can include any animation clips that include the type of character associated with the LIK pose prediction system. For example, an LIK pose prediction system for human posing would require that the LIK pose prediction system is trained using animation clips of human motion; whereas, an LIK pose prediction system for octopus posing would require that the LIK pose prediction system is trained using animation clips of octopus motion.

In accordance with an embodiment, a LIK pose prediction system may be trained for a domain specific context that includes specific motions associated with the context, including boxing, climbing, sword fighting, and the like. A LIK pose prediction system may be trained for a specific domain context by using input animations for training of the LIK pose prediction system that includes animations specific to the domain context. For example, training a LIK pose prediction system for predicting fighting poses should include using a plurality of input fighting animation sequences.

Data Augmentation

In accordance with an embodiment, data augmentation may be used to artificially augment a size of an input training set (e.g., the plurality of input poses), the augmenting providing for an almost infinite motion data input. During training of an LIK pose prediction system, the data augmentation may include randomly translating and randomly rotating character poses in the plurality of input poses. The random translations may be performed in any direction. The addition of random translations of input poses may increase robustness of the LIK pose prediction system model by providing a greater range of input data. Furthermore, the addition of random translations can increase the possible applications of the LIK pose prediction system along with increasing the output quality of the LIK pose prediction system when posing a character. For example, the addition of random translations allows for the LIK pose prediction system to generate automatic body translation while generating a pose using a hierarchy of neural networks. For example, the LIK pose prediction system may generate a translation of a character in addition to providing a pose for the character in order to more closely match inputs (e.g., input effectors) to the generated output pose, since some generated poses may look more natural if accompanied by an additional translation. As a further example, consider a human character that includes input effectors describing position for the hands and feet (e.g., as received in operation 102), the addition of random translations during training will allow the LIK pose prediction system to predict a natural position of the character body in a world space from the input effectors of the hands and feet position. In accordance with an embodiment, the random rotations may only be performed around a vertical axis, as character poses are typically highly dependent on gravity. The addition of random rotation in input data is also important to train an LIK pose prediction system to learn automatic full or partial body rotation that may not be present in the original input data. Furthermore, the addition of random rotations also allows for the LIK pose prediction system to generate automatic body rotation while generating a pose using a hierarchy of neural networks. For example, the LIK pose prediction system may generate a rotation of a character in addition to providing a pose for the character in order to more closely match inputs (e.g., input effectors) to the generated output pose, since some generated poses may look more natural if accompanied by an additional rotation.

In accordance with an embodiment, the data augmentation may include augmentation based on selecting a plurality of different subsets of effectors as inputs (e.g. a first combination of hips and hands, a second combination could be head and feet, and the like). This leads to exponential growth in a number of unique training samples in a training dataset that have a different number and type of effectors. The above described data augmentation, including a selecting of a plurality of different subsets of effectors as inputs, allows a trained LIK pose prediction system to process a variable number and type of input effectors. In accordance with an embodiment, the LIK pose prediction system model is not trained for a fixed number and type of inputs; instead, it is configured to handle any number of input effectors (and/or combinations of different effector types), each of which may have its own semantic meaning.

In accordance with an embodiment, the data augmentation may include augmentation based on a selecting of a plurality of different number of input effectors during training. For example, during training, the LIK pose prediction system may be forced to make predictions for all joints (e.g., for all joints in a character rig) based on any arbitrary subset of effector inputs.

In accordance with an embodiment, the data augmentation may include augmentation based on forcing the LIK pose prediction system to process random combinations of effector types during a training. Accordingly, the LIK pose prediction system may learn (e.g., during a training) to process both angular and positional measurements, increasing a flexibility of the trained network. For example, during a training, for any given sample, the LIK pose prediction system can be forced to predict all joints (e.g., for all joints in a character rig) based on a first combination of effector types (e.g., 3 joint positional effectors and 4 look-at effectors). In addition, for another sample, the LIK pose prediction system can be forced to predict all joints (e.g., for all joints in a character rig) based on a second combination of effector types (e.g., 10 joint positional effectors and 5 look-at effectors).

In accordance with an embodiment, the data augmentation may include augmentation based on forcing LIK pose prediction system to process input samples while randomly choosing a weight (e.g., importance level) for each effector. This results in an exponential growth of a number of unique input samples during training.

In accordance with an embodiment, the data augmentation may include augmentation based on adding random noise to coordinates and/or angles within each effector during a training. In accordance with an embodiment, a variance of the added noise during training may be configured so that it is synchronous with a weight (e.g., importance level) of an effector. This augmentation specifically forces the network to learn to respect certain effectors (e.g., effectors with a high weight) more than others (e.g., effectors with a low weight), on top of providing data augmentation. In accordance with an embodiment, data augmentation and training with the addition of random noise may have applications for processing results of monocular pose estimation, wherein each joint detection provided by a lower level pose estimation routine is accompanied with a measure of confidence.

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

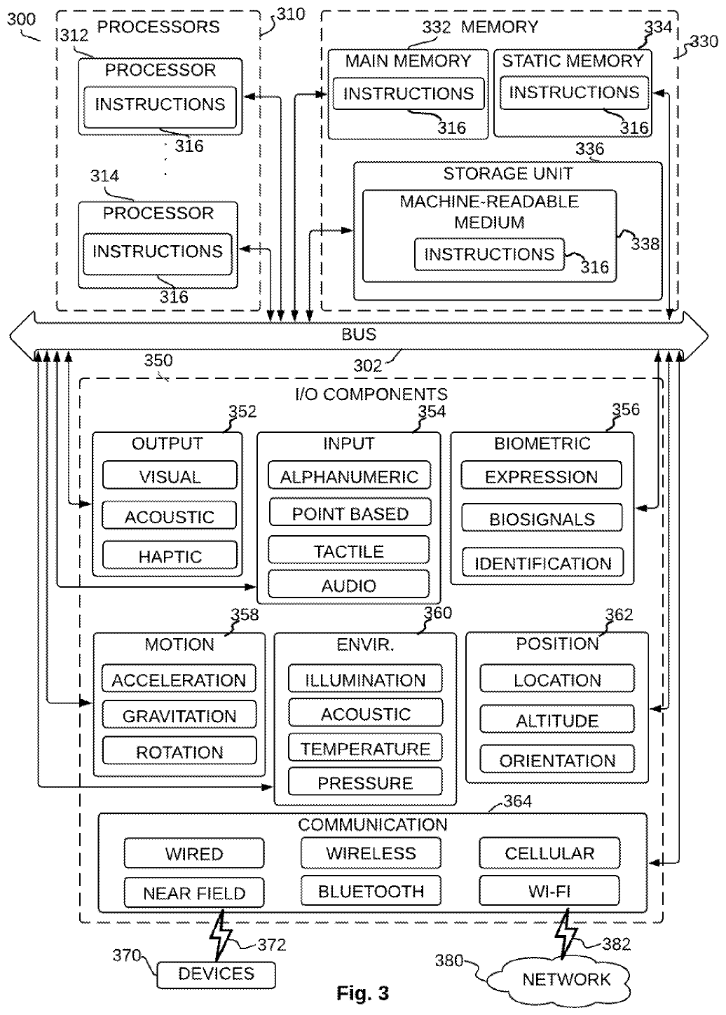

FIG. 2 is a block diagram 200 illustrating an example software architecture 202, which may be used in conjunction with various hardware architectures herein described to provide components of the AI assisted character pose authoring system which may perform the AI assisted character pose authoring method 100. FIG. 2 is a non-limiting example of a software architecture and it will be appreciated that many other architectures may be implemented to facilitate the functionality described herein. The software architecture 202 may execute on hardware such as a machine 300 of FIG. 3 that includes, among other things, processors 310, memory 330, and input/output (I/O) components 350. A representative hardware layer 204 is illustrated and can represent, for example, the machine 300 of FIG. 3. The representative hardware layer 204 includes a processing unit 206 having associated executable instructions 208. The executable instructions 208 represent the executable instructions of the software architecture 202, including implementation of the methods, modules and so forth described herein. The hardware layer 204 also includes memory/storage 210, which also includes the executable instructions 208. The hardware layer 204 may also comprise other hardware 212.

In the example architecture of FIG. 2, the software architecture 202 may be conceptualized as a stack of layers where each layer provides particular functionality. For example, the software architecture 202 may include layers such as an operating system 214, libraries 216, frameworks or middleware 218, applications 220 and a presentation layer 244. Operationally, the applications 220 and/or other components within the layers may invoke application programming interface (API) calls 224 through the software stack and receive a response as messages 226. The layers illustrated are representative in nature and not all software architectures have all layers. For example, some mobile or special purpose operating systems may not provide the frameworks/middleware 218, while others may provide such a layer. Other software architectures may include additional or different layers.

The operating system 214 may manage hardware resources and provide common services. The operating system 214 may include, for example, a kernel 228, services 230, and drivers 232. The kernel 228 may act as an abstraction layer between the hardware and the other software layers. For example, the kernel 228 may be responsible for memory management, processor management (e.g., scheduling), component management, networking, security settings, and so on. The services 230 may provide other common services for the other software layers. The drivers 232 may be responsible for controlling or interfacing with the underlying hardware. For instance, the drivers 232 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 216 may provide a common infrastructure that may be used by the applications 220 and/or other components and/or layers. The libraries 216 typically provide functionality that allows other software modules to perform tasks in an easier fashion than to interface directly with the underlying operating system 214 functionality (e.g., kernel 228, services 230 and/or drivers 232). The libraries 316 may include system libraries 234 (e.g., C standard library) that may provide functions such as memory allocation functions, string manipulation functions, mathematic functions, and the like. In addition, the libraries 216 may include API libraries 236 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 216 may also include a wide variety of other libraries 238 to provide many other APIs to the applications 220 and other software components/modules.

The frameworks 218 (also sometimes referred to as middleware) provide a higher-level common infrastructure that may be used by the applications 220 and/or other software components/modules. For example, the frameworks/middleware 218 may provide various graphic user interface (GUI) functions, high-level resource management, high-level location services, and so forth. The frameworks/middleware 218 may provide a broad spectrum of other APIs that may be utilized by the applications 220 and/or other software components/modules, some of which may be specific to a particular operating system or platform.

The applications 220 include built-in applications 240 and/or third-party applications 242. Examples of representative built-in applications 240 may include, but are not limited to, a contacts application, a browser application, a book reader application, a location application, a media application, a messaging application, and/or a game application. Third-party applications 242 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 242 may invoke the API calls 224 provided by the mobile operating system such as operating system 214 to facilitate functionality described herein. The applications 220 may include an AI assisted pose module 243 which can perform the operations in the method 100 described in FIG. 1.

The applications 220 may use built-in operating system functions (e.g., kernel 228, services 230 and/or drivers 232), libraries 216, or frameworks/middleware 218 to create user interfaces to interact with users of the system. Alternatively, or additionally, in some systems, interactions with a user may occur through a presentation layer, such as the presentation layer 244. In these systems, the application/module “logic” can be separated from the aspects of the application/module that interact with a user.

Some software architectures use virtual machines. In the example of FIG. 2, this is illustrated by a virtual machine 248. The virtual machine 248 creates a software environment where applications/modules can execute as if they were executing on a hardware machine (such as the machine 300 of FIG. 3, for example). The virtual machine 248 is hosted by a host operating system (e.g., operating system 214) and typically, although not always, has a virtual machine monitor 246, which manages the operation of the virtual machine 248 as well as the interface with the host operating system (i.e., operating system 214). A software architecture executes within the virtual machine 248 such as an operating system (OS) 250, libraries 252, frameworks 254, applications 256, and/or a presentation layer 258. These layers of software architecture executing within the virtual machine 248 can be the same as corresponding layers previously described or may be different.

FIG. 3 is a block diagram illustrating components of a machine 300, according to some example embodiments, configured to read instructions from a machine-readable medium (e.g., a machine-readable storage medium) and perform any one or more of the methodologies discussed herein. Specifically, FIG. 3 shows a diagrammatic representation of the machine 300 in the example form of a computer system, within which instructions 316 (e.g., software, a program, an application, an applet, an app, or other executable code) for causing the machine 300 to perform any one or more of the methodologies discussed herein may be executed. As such, the instructions 316 may be used to implement modules or components described herein. The instructions transform the general, non-programmed machine into a particular machine programmed to carry out the described and illustrated functions in the manner described. In alternative embodiments, the machine 300 operates as a standalone device or may be coupled (e.g., networked) to other machines. In a networked deployment, the machine 300 may operate in the capacity of a server machine or a client machine in a server-client network environment, or as a peer machine in a peer-to-peer (or distributed) network environment. The machine 300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 316, sequentially or otherwise, that specify actions to be taken by the machine 300. Further, while only a single machine 300 is illustrated, the term “machine” shall also be taken to include a collection of machines that individually or jointly execute the instructions 316 to perform any one or more of the methodologies discussed herein.

The machine 300 may include processors 310, memory 330, and input/output (I/O) components 350, which may be configured to communicate with each other such as via a bus 302. In an example embodiment, the processors 310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 312 and a processor 314 that may execute the instructions 316. The term “processor” is intended to include multi-core processor that may comprise two or more independent processors (sometimes referred to as “cores”) that may execute instructions contemporaneously. Although FIG. 3 shows multiple processors, the machine 300 may include a single processor with a single core, a single processor with multiple cores (e.g., a multi-core processor), multiple processors with a single core, multiple processors with multiples cores, or any combination thereof.

The memory/storage 330 may include a memory, such as a main memory 332, a static memory 334, or other memory, and a storage unit 336, both accessible to the processors 310 such as via the bus 302. The storage unit 336 and memory 332, 334 store the instructions 316 embodying any one or more of the methodologies or functions described herein. The instructions 316 may also reside, completely or partially, within the memory 332, 334, within the storage unit 336, within at least one of the processors 310 (e.g., within the processor's cache memory), or any suitable combination thereof, during execution thereof by the machine 300. Accordingly, the memory 332, 334, the storage unit 336, and the memory of processors 310 are examples of machine-readable media 338.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 316. The term “machine-readable medium” shall also be taken to include any medium, or combination of multiple media, that is capable of storing instructions (e.g., instructions 316) for execution by a machine (e.g., machine 300), such that the instructions, when executed by one or more processors of the machine 300 (e.g., processors 310), cause the machine 300 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 350 may include a wide variety of components to receive input, provide output, produce output, transmit information, exchange information, capture measurements, and so on. The specific input/output (I/O) components 350 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 350 may include many other components that are not shown in FIG. 3. The input/output (I/O) components 350 are grouped according to functionality merely for simplifying the following discussion and the grouping is in no way limiting. In various example embodiments, the input/output (I/O) components 350 may include output components 352 and input components 354. The output components 352 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 354 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 350 may include biometric components 356, motion components 358, environmental components 360, or position components 362, among a wide array of other components. For example, the biometric components 356 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 358 may include acceleration sensor components (e.g., accelerometer), gravitation sensor components, rotation sensor components (e.g., gyroscope), and so forth. The environmental components 360 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 362 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 350 may include communication components 364 operable to couple the machine 300 to a network 380 or devices 370 via a coupling 382 and a coupling 372 respectively. For example, the communication components 364 may include a network interface component or other suitable device to interface with the network 380. In further examples, the communication components 364 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 370 may be another machine or any of a wide variety of peripheral devices (e.g., a peripheral device coupled via a Universal Serial Bus (USB)).

Moreover, the communication components 364 may detect identifiers or include components operable to detect identifiers. For example, the communication components 364 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 362, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

The term ‘content’ used throughout the description herein should be understood to include all forms of media content items, including images, videos, audio, text, 3D models (e.g., including textures, materials, meshes, and more), animations, vector graphics, and the like.

The term ‘game’ used throughout the description herein should be understood to include video games and applications that execute and present video games on a device, and applications that execute and present simulations on a device. The term ‘game’ should also be understood to include programming code (either source code or executable binary code) which is used to create and execute the game on a device.

The term ‘environment’ used throughout the description herein should be understood to include 2D digital environments (e.g., 2D video game environments, 2D simulation environments, 2D content creation environments, and the like), 3D digital environments (e.g., 3D game environments, 3D simulation environments, 3D content creation environments, virtual reality environments, and the like), and augmented reality environments that include both a digital (e.g., virtual) component and a real-world component.

The term ‘digital object’, used throughout the description herein is understood to include any object of digital nature, digital structure or digital element within an environment. A digital object can represent (e.g., in a corresponding data structure) almost anything within the environment; including 3D models (e.g., characters, weapons, scene elements (e.g., buildings, trees, cars, treasures, and the like)) with 3D model textures, backgrounds (e.g., terrain, sky, and the like), lights, cameras, effects (e.g., sound and visual), animation, and more. The term ‘digital object’ may also be understood to include linked groups of individual digital objects. A digital object is associated with data that describes properties and behavior for the object.

The terms ‘asset’, ‘game asset’, and ‘digital asset’, used throughout the description herein are understood to include any data that can be used to describe a digital object or can be used to describe an aspect of a digital project (e.g., including: a game, a film, a software application). For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more digital objects within a game at runtime (e.g., during execution of the game).

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

I/We claim:

1. A system comprising:
one or computer processors;
one or more computer memories;
a set of instructions stored in the one or more computer memories, the set of instructions configuring the one or more computer processors to perform operations, the operations comprising:
receiving an input, the input describing a manipulation of a character, the input defining one or more effectors;
generating a pose for the character using a learned inverse kinematics (LIK) machine-learning (ML) component, the LIK ML component trained using a motion dataset, the generating of the pose based on one or more criteria, the one or more criteria including explicit intent expressed as the one or more effectors;
adjusting the generated pose using an ordinary inverse kinematics (OIK) component, the OIK component solving an output from the LIK ML component to increase an accuracy at which the explicit intent is reached; and
generating a final pose from the adjusted pose, the generating of the final pose including applying a physics engine (PE) to an output from the OIK component to increase a physics accuracy of the pose.

2. The system of claim 1, wherein the one or more criteria include a naturalness or realism of the pose learned from the training on the motion dataset.

3. The system of claim 1, wherein the one or more effectors define a joint position or an orientation of the pose and the adjusting of the generated pose includes matching the joint position or the orientation.

4. The system of claim 1, wherein the output from the OIK component does not respect one or more constraints specified in the input.

5. The system of claim 1, wherein the adjusting of the generated pose includes using an iterative process to better match one or more target positions included in the input.

6. The system of claim 1, wherein the adjusting of the generated pose includes splitting a skeleton of the character into a plurality of bone chains, the bone chains dynamically configured based on the one or more effectors.

7. The system of claim 1, wherein the applying of the PE engine to the output from the OIK component includes an iterative process during which forces or torques are applied to a simulated version of the character to match the output from the LIK ML component.

8. A non-transitory computer readable storage medium storing a set of instructions that, when executed by one or more computer processors, cause the one or more computer process to perform operations, the operations comprising:
receiving an input, the input describing a manipulation of a character, the input defining one or more effectors;
generating a pose for the character using a learned inverse kinematics (LIK) machine-learning (ML) component, the LIK ML component trained using a motion dataset, the generating of the pose based on one or more criteria, the one or more criteria including explicit intent expressed as the one or more effectors;
adjusting the generated pose using an ordinary inverse kinematics (OIK) component, the OIK component solving an output from the LIK ML component to increase an accuracy at which the explicit intent is reached; and
generating a final pose from the adjusted pose, the generating of the final pose including applying a physics engine (PE) to an output from the OIK component to increase a physics accuracy of the pose.

9. The non-transitory computer readable storage medium of claim 8, wherein the one or more criteria include a naturalness or realism of the pose learned from the training on the motion dataset.

10. The non-transitory computer readable storage medium of claim 8, wherein the one or more effectors define a joint position or an orientation of the pose and the adjusting of the generated pose includes matching the joint position or the orientation.

11. The non-transitory computer readable storage medium of claim 8, wherein the output from the OIK component does not respect one or more constraints specified in the input.

12. The non-transitory computer readable storage medium of claim 8, wherein the adjusting of the generated pose includes using an iterative process to better match one or more target positions included in the input.

13. The non-transitory computer readable storage medium of claim 8, wherein the adjusting of the generated pose includes splitting a skeleton of the character into a plurality of bone chains, the bone chains dynamically configured based on the one or more effectors.

14. The non-transitory computer readable storage medium of claim 8, wherein the applying of the PE engine to the output from the OIK component includes an iterative process during which forces or torques are applied to a simulated version of the character to match the output from the LIK ML component.

15. A method comprising:
receiving an input, the input describing a manipulation of a character, the input defining one or more effectors;
generating a pose for the character using a learned inverse kinematics (LIK) machine-learning (ML) component, the LIK ML component trained using a motion dataset, the generating of the pose based on one or more criteria, the one or more criteria including explicit intent expressed as the one or more effectors;
adjusting the generated pose using an ordinary inverse kinematics (OIK) component, the OIK component solving an output from the LIK ML component to increase an accuracy at which the explicit intent is reached; and
generating a final pose from the adjusted pose, the generating of the final pose including applying a physics engine (PE) to an output from the OIK component to increase a physics accuracy of the pose.

16. The method of claim 15, wherein the one or more criteria include a naturalness or realism of the pose learned from the training on the motion dataset.

17. The method of claim 15, wherein the one or more effectors define a joint position or an orientation of the pose and the adjusting of the generated pose includes matching the joint position or the orientation.

18. The method of claim 15, wherein the output from the OIK component does not respect one or more constraints specified in the input.

19. The method of claim 15, wherein the adjusting of the generated pose includes using an iterative process to better match one or more target positions included in the input.

20. The method of claim 15, wherein the adjusting of the generated pose includes splitting a skeleton of the character into a plurality of bone chains, the bone chains dynamically configured based on the one or more effectors.
